(19) United States
(12) Patent Application Publication
(10) Pub. No.: US 2013/0213782 A1
(43) Pub. Date: Aug. 22, 2013

(54) KEY AND ELECTRONIC DEVICE USING SAME

(71) Applicant: YUAN-MING WANG, Shenzhen City (CN)

(72) Inventor: YUAN-MING WANG, Shenzhen City (CN)

(21) Appl. No.: 13/631,887

(22) Filed: Sep. 29, 2012

(30) Foreign Application Priority Data
Feb. 22, 2012 (CN) 201210040229.9

(51) Int. Cl. H01H 3/00

(52) U.S. Cl. 200/329

(57) ABSTRACT

An electronic device includes a housing and a key. The housing defines a mounting hole. The key is moveably connected to the housing, and includes a switch and a key cap engaging with the switch. The key cap comprises an operating component and an actuating component secured to the operating component. The actuating component includes a positioning component secured to the actuating component. When the actuating component extends through the mounting hole, the positioning component is deformed and cooperates with the operating component to abut opposite sides of the housing, for securing the key to the housing.

### BACK

1. Technical Field

The present disclosure relates to electronic devices; and more particularly, to an electronic device having a key.

2. Description of Related Art

Electronic devices, such as computers, DVD players and mobile phones, may have a key for receiving users' operations, for example, turning on/off the power. The key includes a key cap having an actuating component, and a switch. The actuating component triggers the switch when the key cap is pressed. However, the key cap is secured to the housing by virtue of other fixing members, which is inconvenient to be assembled.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of an electronic device having a key.

FIG. 2 is a partial disassembled view of the electronic device of FIG. 1.

FIG. 3 is similar to FIG. 2, but viewed from another aspect.

FIG. 4 is a view of the key in FIG. 3 from another aspect.

FIG. 5 is a partial assembled view of the electronic device of FIG. 2.

### DETAILED DESCRIPTION

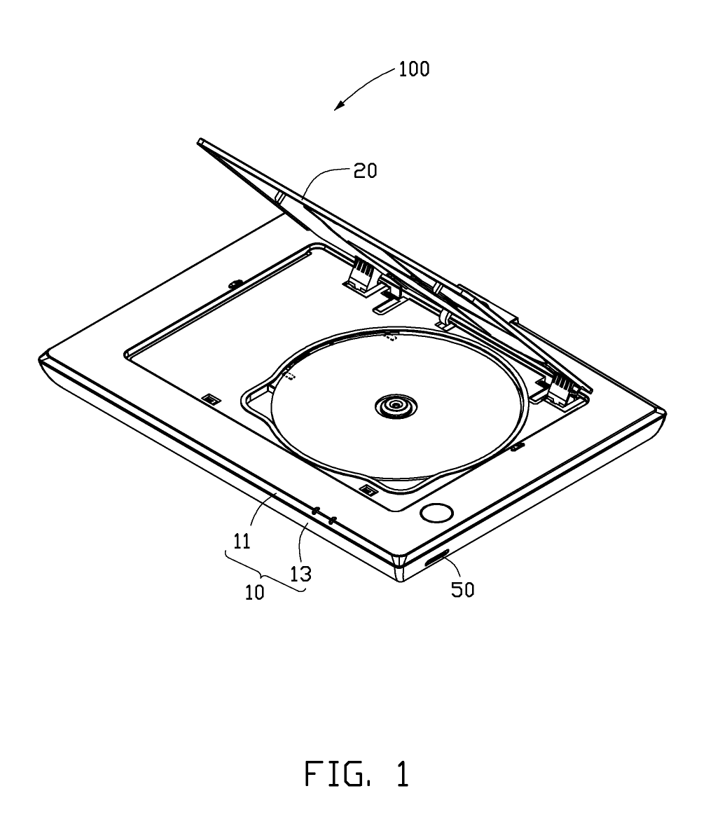

Referring to FIG. 1, an electronic device 100 includes a housing 10, a cover 20, and a key 50. The cover 20 rotatably couples to the hosing 10, and is capable of being closed and opened relative to the housing 10 by an external force. The key 50 is movably arranged on the housing 10 for receiving users' operations. The electronic device 100 may be a computer, DVD player and a mobile phone. In the embodiment, the electronic device 100 is a DVD player.

The housing 10 is substantially rectangular, and includes a top case 11, and a bottom case 13 opposite to the top case 11. The top case 11 engages with the bottom case 13 to define a receiving space (not shown), for receiving components of the electronic device 100.

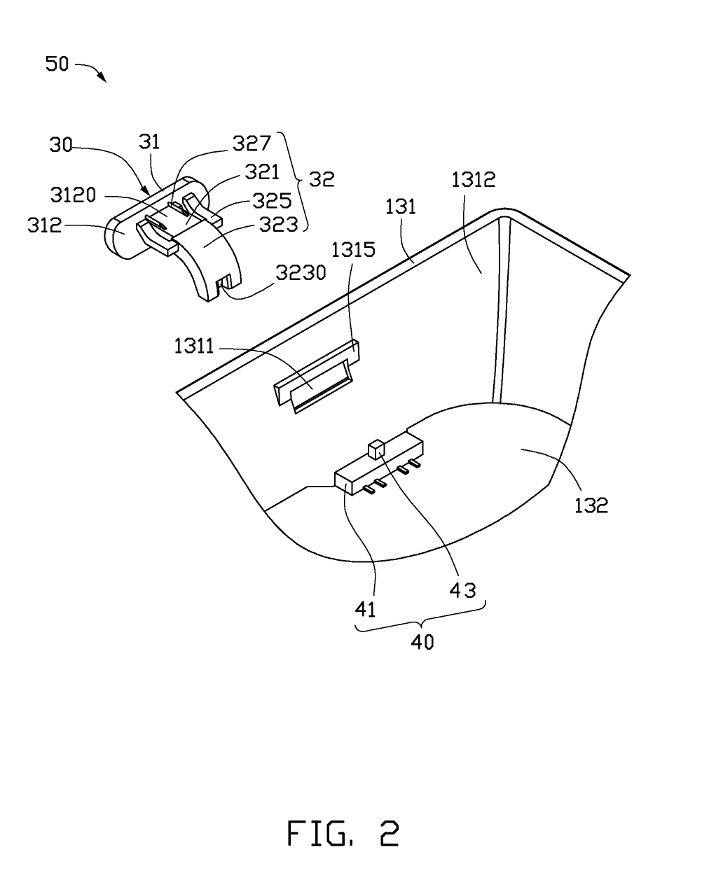

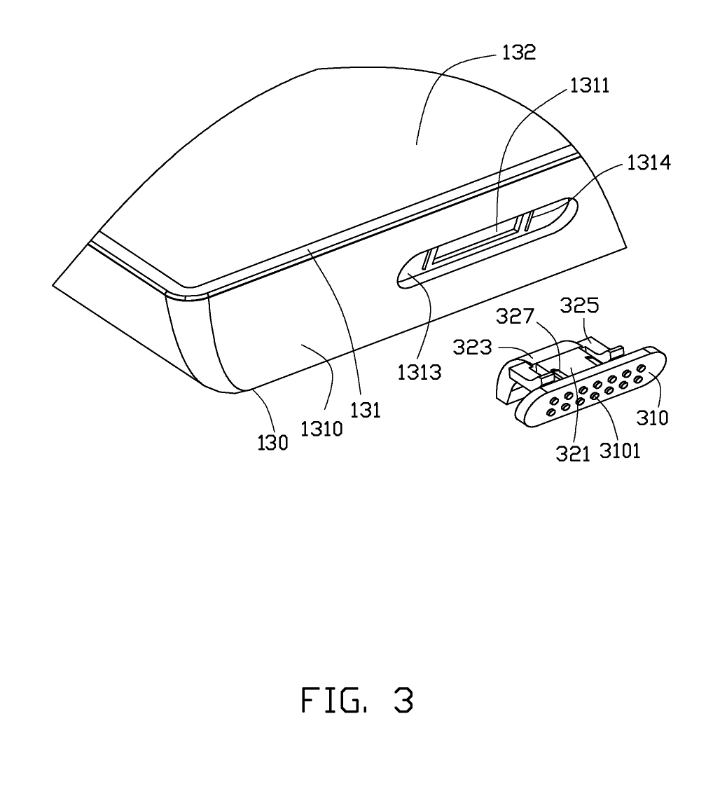

Referring to FIGS. 2 and 3, the bottom case 13 includes a bottom wall 130 and a plurality of sidewalls extending from the bottom wall 130. A circuit board 132 is arranged on a surface of the bottom wall 130 opposite to the top case 11. One of the sidewalls (referred herein as the first sidewall 131) includes an outer surface 1310 and an inner surface 1312 opposite to the outer surface 1310. The outer surface 1310 defines a receiving portion 1313. The receiving portion 1313 is recessed in the outer surface 1310 and extends in a direction parallel to the bottom wall 130. The bottom of the receiving portion 1313 defines a mounting hole 1311 allowing the receiving portion 1313 to communicate with the receiving space. The mounting hole 1311 is defined at the middle portion of the bottom of the receiving portion 1313 and extends in the same direction as the receiving portion 1313. Two friction ribs 1314 protrude from the bottom of the receiving portion 1313 and are arranged at opposite sides of the mounting hole 1311 symmetrically about the center of the mounting hole 1311. A mounting base 1315 protrudes from the inner surface 1312. A surface of the mounting base 1315 opposite to the inner surface 1312 is perpendicular to the bottom wall 130.

The key 50 is movably coupled to the first sidewall 131. The key 50 includes a key cap 30 and a switch 40 which can be engaged with the key cap 30.

The key cap 30 is slidably secured to the first sidewall 131 for triggering the switch 40. The key cap 30 includes an operating portion 31 and an actuating component 32. The operating portion 31 is slidably received in the receiving portion 1313. The operating component 31 includes a first surface 310 and a second surface 312 opposite to the first surface 310. The first surface 310 is exposed from the outer surface 1310. A plurality of skid resisting portions 3101 protrude from the first surface 310 for increasing friction. In the embodiment, the skid resisting portions 3101 are substantially columnar.

The actuating component 32 protrudes from the second surface 312 and is capable of extending through the mounting hole 1311 for engaging with the switch 40. The actuating component 32 includes a first arm 321, a second arm 323, two positioning components 325 and four contacting ribs 327. In the embodiment, the actuating component 32 is integrated with the operating component 31.

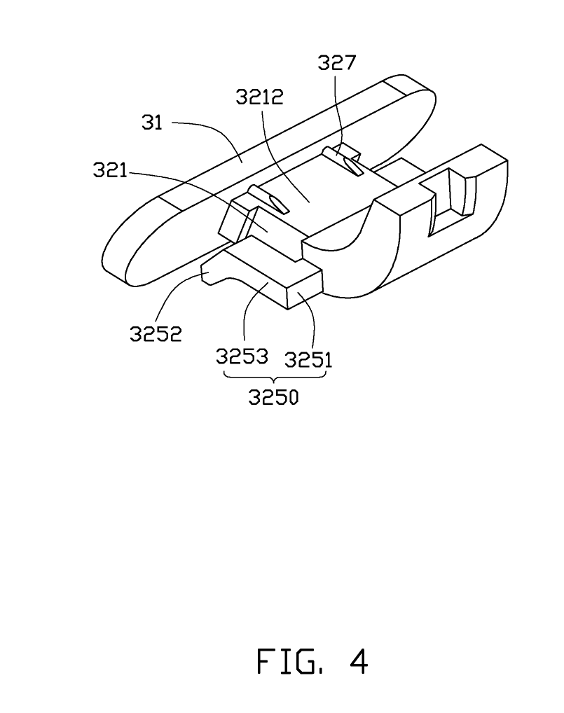

The first arm 321 perpendicularly protrudes from the second surface 312, and includes an upper surface 3210 and a lower surface 3212 (shown in FIG. 4) opposite to the upper surface 3210. The second arm 323 is substantially an arc, and bends from an end of the first arm 321 away from the second surface 312. An end of the second arm 323 away from the first arm 321 defines a latching groove 3230 for engaging with the switch 40.

Referring to FIG. 4, the two positioning components 325 are secured to opposite sides of the second arm 32. The two positioning components 325 are made of elastic material. Each positioning component 325 includes a connecting portion 3250 and a resisting portion 3252. Each connecting portion 3250 is substantially L-shaped, and includes a first connecting portion 3251 and a second connecting portion 3253. The first connecting portions 3251 perpendicularly extend from opposite sides of the second arm 323 and are adjacent to the first arm 321. The second connecting portions 3253 perpendicularly extend from ends of the first connecting portions 3251 away from the second arm 323, and extend toward the operating component 31. The second connecting portions 3253 maintain a predetermined gap between themselves and the second arm 323. The resisting portions 3252 are bent from ends of the corresponding second connecting portions 3253 away from the first connecting portions 3251. The bending direction of the resisting portions 3252 is the reverse of the bending direction of the second arms 323. The distance between ends of the resisting portions 3252 away from the first connecting portions 3251 and the second surface 312 is substantially equal to the distance between the outer surface 1310 and an end of the mounting base 1315 opposite to the inner surface 1312.

Referring again to FIG. 2, two of the contacting ribs 327 protrude from the upper surface 3210 and are distanced from each other. The other two contacting ribs 327 protrude from the lower surface 3212 and are symmetrical to the corresponding second ribs 327 on the upper surface 3210 (shown in FIG. 3). The distance between ends of the contacting ribs 327 away from the first arm 321 is substantially equal to the vertical width of the mounting hole 1311.

The switch 40 is arranged on a surface of the circuit board 132 facing the top case 11. The switch 40 includes a body 41 and a triggering portion 43. The body 41 is adjacent to the first sidewall 131. The triggering portion 43 protrudes from a side of the body 41 and faces the top case 11. The projection of the triggering portion 43 on the first sidewall 131 substantially corresponds to the mounting hole 1311. The shape of the triggering portion 43 matches the shape of the latching groove 3230.

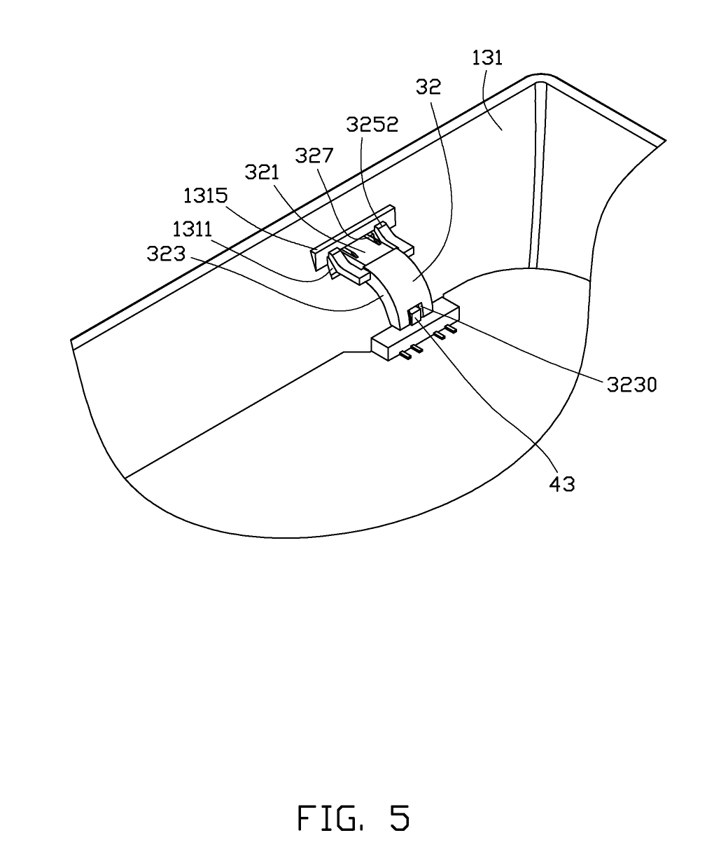

Referring FIG. 5, in assembly, the second arm 323 extends through the mounting hole 1311, and the two resisting portions 3252 elastically deform to allow the operating component 31 to be received in the receiving groove 1313 and to abut the two friction ribs 1314. The triggering portion 1304 is secured to the latching groove 3230. In this state, the two resisting portions 3252 rebound and abut the mounting base 1315. The operating component 31 abuts the outer surface 1310 and cooperates with the two resisting portions 3252 to fix the key 30 to the first sidewall 131. The four contacting ribs 327 make contact with the edges of the mounting hole 1311 for reducing the friction between the actuating component 32 and the mounting hole 1311. The second surface 312 makes contact with the two friction ribs 1314 for reducing the friction between the operating component 31 and the receiving groove 1313. Thus, the key 30 is secured to and stable on the first sidewall 131, with the operating component 31 slidably received in the mounting hole 1311 for operating the switch 40.

Although information and the advantages of the present embodiments have been set forth in the foregoing description, together with details of the structures and functions of the present embodiments, the disclosure is illustrative only; changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a housing defining a mounting hole;
a key moveably connected to the housing, the key comprising:
a switch arranged on the housing; and
a key cap capable of engaging with the switch, the key cap comprising:
an operating component movably arranged on the housing;
an actuating component secured to the operating component for triggering the switch; and
a positioning component secured to the actuating component;
wherein when the actuating component extends through the mounting hole, the positioning component is deformed and cooperates with the operating component to respectively abut opposite sides of the housing, for securing the key to the housing.

2. The electronic device as claimed in claim 1, wherein the first sidewall includes an outer surface and an inner surface opposite to the outer surface; the operating component is slidably secured to the outer surface and the positioning component is slidably secured to the inner surface.

3. The electronic device as claimed in claim 2, wherein the positioning component comprises a connecting portion connected to the actuating component and a resisting portion; the resisting portion is arranged between the operating component and the connecting portion for engaging with the operating component to abut opposite sides of the housing.

4. The electronic device as claimed in claim 3, wherein the resisting portion is bended away from the connecting portion and abuts the housing and keeps a predetermined distance with the operating component.

5. The electronic device as claimed in claim 4, wherein the inner surface comprises a mounting base, the resisting portion abuts the mounting base; the distance between an end of the resisting portion adjacent to the operating component and a corresponding surface of the operating component is equal to the outer surface of the first sidewall and a surface of the mounting base opposite to the inner surface.

6. The electronic device as claimed in claim 1, wherein the positioning component is made of elastic material.

7. The electronic device as claimed in claim 1, wherein the actuating component comprises a first arm and a second arm secured to the first arm; the first arm extends from the operating component, the second arm is bended from the first arm opposite to the operating component for engaging with the switch.

8. The electronic device as claimed in claim 1, wherein the actuating component comprises at least one contacting rib, when the actuating component is received in the mounting hole, the at least one contacting rib abuts the corresponding edge of the mounting hole for reducing friction between the actuating component and the mounting hole.

9. The electronic device as claimed in claim 1, wherein the actuating component is integrally formed with the operating component.

10. The electronic device as claimed in claim 1, wherein the outer surface defines a receiving portion, and the mounting hole is defined in the bottom of the receiving portion; at least one friction rib protrudes out from the bottom of the receiving portion for contacting with the operating component.

11. A key movably fixed to a housing of an electronic device, the housing defines a mounting hole, the key comprising:
a switch arranged on the housing; and
a key cap capable of engaging with the switch, the key cap comprising:
an operating component moveably arranged on the housing;
an actuating component secured to the operating component for triggering the switch; and
a positioning component secured to the actuating component;
wherein when the actuating component extends through the mounting hole, the positioning component is deformed and cooperates with the operating component to respectively abut opposite sides of the housing, for securing the key to the housing.

12. The key as claimed in claim 11, wherein the first sidewall includes an outer surface and an inner surface opposite to the outer surface; the operating component is slidably secured to the outer surface and the positioning component is slidably secured to the inner surface.

13. The key as claimed in claim 12, wherein the positioning component comprises a connecting portion connected to the actuating component and a resisting portion; the resisting portion is arranged between the operating component and the connecting portion for engaging with the operating component to abut opposite sides of the housing.

14. The key as claimed in claim 13, wherein the resisting portion is bended away from the connecting portion for abutting the housing and keeps a predetermined distance with the operating component.

15. The key as claimed in claim 14, wherein the inner surface comprises a mounting base, the resisting portion abuts the mounting base; the distance between an end of the resisting portion adjacent to the operating component and a corresponding surface of the operating component is equal to the outer surface and an surface of the mounting base opposite to the inner surface.

16. The key as claimed in claim 11, wherein the positioning component is made of elastic material.

17. The key as claimed in claim 11, wherein the actuating component comprises a first arm and a second arm secured to the first arm; the first arm extends from the operating component, the second arm is bended away from the first arm opposite to the operating component for engaging with the switch.

18. The key as claimed in claim 11, wherein the actuating component comprises at least one contacting rib, when the actuating component is received in the mounting hole, the at least one contacting rib abuts the corresponding edge of the mounting hole for reducing the friction between the actuating component and the mounting hole.

19. The key as claimed in claim 11, wherein the actuating component is integrally formed with the operating component.

20. The key as claimed in claim 11, wherein the outer surface defines a receiving portion, and the mounting hole is defined in the bottom of the receiving portion; at least one friction rib protrudes out from the bottom of the receiving portion for contacting with the operating component.
